(19) United States
(12) Patent Application Publication
(10) Pub. No.: US 2021/0225160 A1
(43) Pub. Date: Jul. 22, 2021

(54) ENVIRONMENT SIGNATURES AND DEPTH PERCEPTION

(71) Applicant: Hewlett-Packard Development Company, L.P., Spring, TX (US)

(72) Inventors: Tiago de Padua, Porto Alegre (BR); Adilson Arthur Mohr, Porto Alegre (BR); Marco Goncalves Lovato, Vancouver, WA (US); Diego Gimenez Pedroso, Porto Alegre (BR)

(73) Assignee: Hewlett-Packard Development Company, L.P., Spring, TX (US)

(21) Appl. No.: 17/047,433

(22) PCT Filed: Oct. 9, 2018
(86) PCT No.: PCT/US2018/055006

§ 371 Date: Oct. 14, 2020

(51) Int. Cl. G08C 17/02; G01D 21/02; G01C 3/00

(52) U.S. Cl. CPC G08C 17/02; G01D 21/02; G08C 2201/30; G08C 2201/91; G01C 3/00

(57) ABSTRACT

A mobile device may include a processor to receive data from a sensor descriptive of an environment in which the mobile device is present; with an environment signature module, create a signature of the environment defining the characteristics of the environment; and present to a user, via a remote display device, a location identifier based on a comparison between the signature and the currently sensed characteristics of the environment and visual cues indicating objects proximate to the mobile device.

### BACKGROUND

Remotely controlled devices have become ubiquitous in todays society. Some remotely controlled (RC) devices such as drones, cars, and boats are created for enjoyment by the user as a hobby. Other RC devices are used in relatively more serious scenarios such as robots used on bomb disposal and rescue endeavors. Control of these hobby RC devices are done within line of sight of the user so that the user may visually determine whether the RC device is appropriately maneuvering as intended. When not within line of sight, the operator may use a camera to facilitate movement throughout an environment.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a mobile device according to an example of the principles described herein.

FIG. 2 is a block diagram of an environment signature module according to an example of the principles described herein.

FIG. 3 is a flowchart showing a method of determining a location of a device according to an example of the principles described herein.

FIG. 4 is a view of a graphical user interface according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Remotely controlled (RC) devices and/or mobile devices may include a myriad of different types of devices that a user may control remotely. The remote controlling of the RC device may be accomplished through any type of handheld device such as a cell phone, a radio broadcasting device, and a computing device, among others. In these examples, some wavelength of electromagnetic radiation is presented to the RC device to be interpreted by a processor of the RC device. By the interpretation of these electromagnetic signals, the processor may direct a number of motors or other mechanical devices to, for example, move the RC device. This type of communication to the RC device may be described as teleoperation.

Via this teleoperation of the RC device, a user may remotely move the RC device and further cause other devices associated with the RC device to interact with the environment. To facilitate the movement of the RC device through an environment, the RC device may include a camera. Images received by the camera may be sent to a user via returning electromagnetic signals and to a display device for display to the user. This may allow the user to see the environment but the simple two-dimensional (2D) image does not provide the user with depth perception. Further, the images may provide a limited field of view (FoV) even if more than one camera is used with the RC device. The ability to detect objects out of field of view (FoV) and avoid them is limited. Further, where the video from the camera is unclear or non-existent, the RC device may be lost to a user who was dependent on the video feed to navigate the RC device. Without more information, the RC device may be lost and unrecoverable. This is also true for any non-stationary or mobile devices, such as smartphones, cameras, notebooks, robots (autonomous or not), etc.

The present specification describes a mobile device that includes a processor to: receive data from a sensor descriptive of an environment in which the mobile device is present; with an environment signature module, create a signature of the environment defining the characteristics of the environment; and present to a user, via a remote display device, a location identifier based on a comparison between the signature and the currently sensed characteristics of the environment and visual cues indicating objects proximate to the mobile device.

The present specification also describes an environment signature module that includes a plurality of sensors to detect characteristics of an environment a mobile device is physically present within; a signature creation module to create and store a signature comprising data descriptive of characteristics of the environment based; a tag creation module to receive input describing a tag to be associated with the signature; and a comparison module to compare the signature to currently detected characteristics of an environment the mobile device is passing through.

The present specification further describes a method of determining a location of a device that includes detecting, with a plurality of sensors, characteristics of an environment, in real time, the device is present within; comparing the detected characteristics of the environment with a plurality of signatures within a look-up table, each signature descriptive of a distinct environment; and providing an indication to a viewer on a display device, data descriptive of the environment.

As used in the present specification and in the appended claims, the term “remote-controlled” is meant to be understood as an ability to control a device from a remote position. This may, in some examples, include controlling the movement or functioning of the remotely controlled device or controlling movement or functioning of auxiliary devices coupled to the remotely controlled device. The remote-controlled devices described herein may implement any wireless signals to accomplish the remote control of the remote-control device.

As used in the present specification and in the appended claims, the term “mobile” is meant to be understood as capable of moving or being moved. Thus, the examples presented herein may describe a mobile device and/or remotely controlled device that may be moved by user interaction or not.

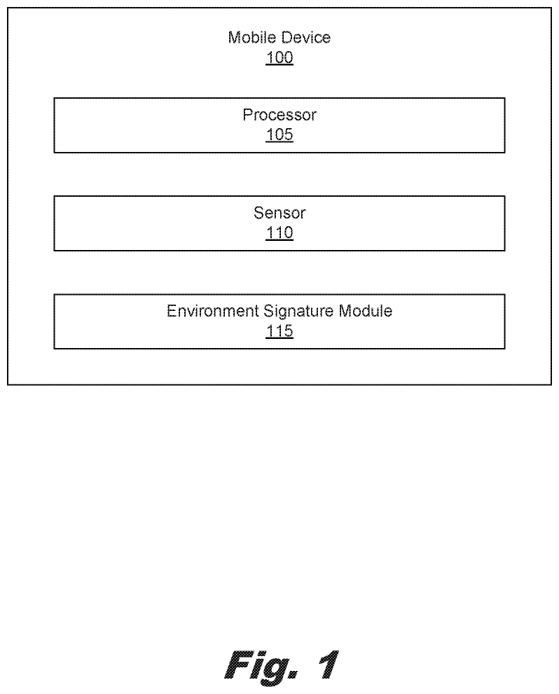

Turning now to the figures, FIG. 1 is a block diagram of a mobile device (100) according to an example of the principles described herein. The mobile device (100) may be any mobile device. In an example, the mobile device (100) may be remotely controlled device that implements teleoperation processes to control the movement and/or function of the RC device (100) remote from a user. In this example, the RC device may include a number of mechanical instruments coupled thereto that allow the RC device to interact with an environment. By way of example, these mechanical instruments may include a mechanical arm, a drill, a scoop, a plow, a series of tracks, a number of wheels, a gimbal system, and a projectile delivery system, among others. Each of these mechanical instruments and the RC device may be communicatively coupled to a processor (105). In an example, the mobile device (100) may be a computing device that may not move on its own but may be movable by a user such as a mobile phone, a tablet device, and a laptop computing device, among others.

The processor (105) may be communicatively coupled to a wireless antenna to receive the signals remotely from a user-operated handheld device. Upon receipt of the signals, the processor (105) may interpret these signals as actions to be taken at the mobile device (100). The processor (105) may then send signals to the devices associated with the mobile device (100) to move or otherwise cause the mechanical devices to perform their respective functions. The processor (105) may, in an example, be communicatively coupled to a data storage device that maintains computer readable program code to be executed by the processor (105) in order to achieve the functionalities described herein.

The mobile device (100) may include a number of sensors (110). Each sensor (110) may be communicatively coupled to the processor (105) so that the processor (105) may receive data descriptive of an environment in which the mobile device (100) is present. The type of data received may be dependent, in an example, on the type of sensor (110) used to describe the environment. By way of example, the sensor (110) may be a thermometer which relays data descriptive of a temperature of the environment. In an example, the sensor (110) may be a microphone that records or relays audio to the processor. In an example, the sensor (110) may be a barometer that provides atmospheric pressure measurements to the processor (105). In an example, the sensor (110) is an accelerometer that detects the acceleration of the mobile device (100) and relays that data to the processor (105). In an example, the sensor (110) is a speedometer that measures the speed of the mobile device (100) and relays that information to the processor (105). In an example, the sensor (110) is a camera that records images presented around the mobile device (100) and provides those images to the processor (105). In an example, the sensor (110) may be a photodetector that measures any ambient light around the mobile device (100). In an example, the sensor (110) is a hydrometer that measures a humidity around the mobile device (100). In an example, the sensor (110) is a rangefinder that measures a distance to objects around the device (100).

In any of these examples, the processor (105) may receive the data from the sensors (110) and process the data further for delivery to a display device remote to the user. In an example, the processor (105) may receive the data from the sensors (110) and process the data using a signature module (115) described herein. In an example, the processor (105) may receive the data from the sensors (110) and forward that data to another device and/or processor to be implemented as described herein.

In an example, the signature module (115) may be computer readable program code stored on a data storage device and accessible by the processor (105). Upon execution by the processor (105) of this computer readable program code defining the signature module (115), the processor (105) may process the data received from the sensors (110) and create a signature defining characteristics of the environment. In an example, the signatures created may include all of the data obtained by some or all of the sensors (110) and stored for future reference. In an example, the signatures may be stored as a look-up table. In these examples, any signature may be timestamped and associated with that timestamp or given a name via, for example, user input. The name may be descriptive of a location such as “bathroom,” “hallway,” “town hall,” “Green Street,” “Lakeside Park,” etc.

During a subsequent operation of the mobile device (100), any currently sensed data from the sensors (110) may be compared to any previously created signature. The comparison may be made via, for example a comparison module. The comparison module may, when executed by the processor (105), receive data indicative of the data from the sensors (110) and run a look up process comparing the data from each of the sensors (110) to each of the previously created signatures. Where a match is found, the processor (105) may indicate to a user where the mobile device (100) is located. In an example, a match is found if the similarities between the currently obtained data from the sensors (110) and any of the signatures are above a threshold. As such, the processor (105) may determine if the threshold similarity has been reached to determine that a match has occurred. If a match has occurred, the user may be so notified by, for example, a display device remote to the mobile device (100) but viewable by the user.

By way of example, the mobile device (100) may be moved to a conference room. The conference room may have certain lighting characteristics, acoustic characteristics, color characteristics, temperature characteristics, pressure characteristics, humidity characteristics, wireless network signals having gradations of signal strength, wirelessly detectable devices, or any other environmental characteristics that may be detected by the sensors (110) described herein. The processor (105) may receive these detected characteristics from each of the sensors (110) and execute the signature module (115) to create a signature related to the current environment. The collection of data from the sensors (110) and processing of that data may occur at any frequency and may be user adjustable. In this example, the signature may be used later if and when the mobile device (100) is directed to the conference room in order to identify those particular environmental characteristics in the conference room and notify the user that the mobile device (100) is in the conference room after the matching process described herein has occurred.

In an example, the processor (105), after receiving the data from each of the sensors (110), may associate data from any of the given sensors (110) with a weight thereby giving those readings more importance. For example, a weight may be associated with an ambient light reading that is less than or greater than a weight associated with a timestamp. Where weights are associated with any give data from any given sensor (110), during the comparison of currently sensed data with the signature, these weights may be part of the calculation as to whether the similarity threshold has been reached resulting in a match between the currently sensed data and any given signature.

In an example, the comparison module may individually compare each of the currently sensed characteristics of the environment with the previously sensed characteristics described in a given signature. By way of example, a currently sensed ambient light data sensed by a photometer may be compared with corresponding ambient light data defined in each signature. In this manner, a total comparison may be determined by averaging out a final comparison score and determining if that score reached the similarity threshold.

In those examples where currently sensed data matches, beyond a threshold limit, a plurality of signatures, the process may include selecting the match having the highest score. In any example, a user may influence the outcome by accepting or rejecting a match and adjusting the weights associated with any of the given data from each of the sensors (110). This may allow the processor (105) of the mobile device (100) to engage in a machine learning process thereby progressively improving performance of the matching process described herein without modification of the computer readable program code described herein. Specific examples are described herein regarding specific methods of calculating the similarity between a signature and the currently sensed environmental characteristics. However, the present specification contemplates the use of any method of calculation.

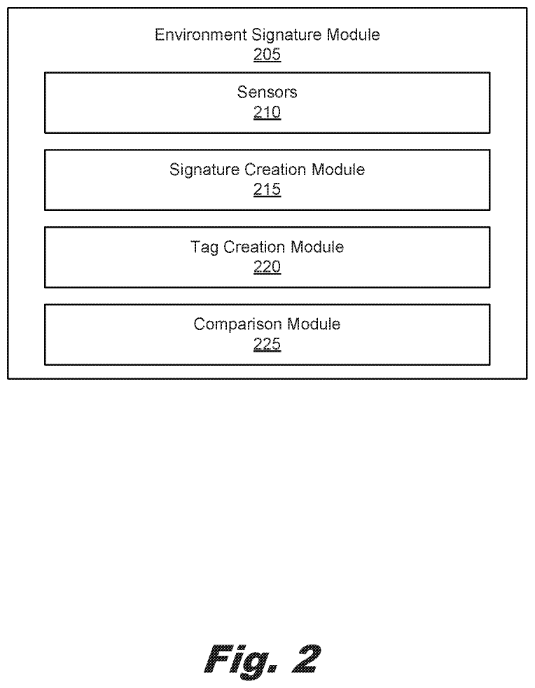

FIG. 2 is a block diagram of an environment signature module (205) on a mobile device according to an example of the principles described herein. The mobile device may be any type of mobile device such as a smartphone, tablet, laptop computing device, the mobile device (100) described in connection with FIG. 1, among other types of mobile devices.

The environment signature generator (205) of the mobile device may include any number of sensors (210) as described herein. The sensors may include, for example, any sensor that may convey to a processor characteristic of an environment around the mobile device. These characteristics may be dependent on the type of sensor (210) available and associated to the mobile device such as a microphone, a barometer, a thermometer, a photodetector, an accelerometer, and a speedometer, a wireless network antenna, among others.

Each of the sensors (210) may provide data to a signature creation module (215). The signature creation module (215) may, when executed by a processor of the mobile device, create and store a signature that include data describing the characteristics of the environment the mobile device is within. As described herein, the signature may be stored in a look-up table for future reference.

The environment signature generator (205) of the mobile device may include a tag creation module (220). The tag creation module (220) may receive data describing a tag to be associated with a signature created by a signature creation module (215). The tag may include any alphanumerical description of the signature. In an example, a user may interface with the mobile device and enter a tag to be associated with any given signature. Example described herein may include a description of a physical location of the mobile device that the characteristics of a signature describes.

The environment signature generator (205) may include a comparison module (225). The comparison module (225) may, upon execution of a processor of the mobile device, receive current data descriptive of characteristics of an environment the mobile device is currently located within. The data may be received by any of the sensors (210) of the mobile device. The comparison module (225) uses this data from each of the sensors (210) and compares it to the data presented in any signature created by the signature creation module (215). If a match is found as described herein, the comparison module (225) may return to a user an indication of the location of the mobile device. In an example, the indication to the user may include the tag associated with the signature.

A described herein, the comparison module (225) may consider any weights applied to any of the data received from any of the sensors (210). These weights may be used to determine if a match has occurred between the currently received data and the signature. If the match to a signature is present at or beyond a threshold limit, the comparison module (225) may return the match to a user of the mobile device. Whether the threshold has been reached may be, in an example, determined by a threshold module. The threshold module may apply a threshold to determine whether the signatures match the currently detected characteristics of the environment.

The mobile device, with its environment signature generator (205), may include a wireless network adapter. The wireless network adapter may communicatively couple the environment signature generator (205) on the mobile device to a display device remote to the environment signature generator (205) and present the user with information regarding the tag associated with the signature.

In an example, the environment signature generator (205) may also present visual cues on the display device indicating objects proximate to the mobile device. In this example, the camera of the mobile device may present a user with a real-tome display of the environment captured by the camera. This may be referred herein as a first-person view (FPV) where the camera continuously presents to a user the images captured by the camera. In this example, the 2D view of the environment presented to the user may be augmented by a number of overlay images placed over the images captured by the camera. These images may include boxes, lines, or other images that are either solid in color or translucent so that the user may see through the object. The objects may further change color or shape based on the distance the object is to the camera of the mobile device.

In an example, the overlay images may be placed over the images presented by the user based on data received from a rangefinder. Because the rangefinder may be one of the many sensors (210) associated with the mobile device, the data from the rangefinder may be presented to both the signature creation module (215) and a video enhancement module. As described herein, the signature creation module (215) may use the data to create a signature. The video enhancement module may receive the data from the rangefinder in order to place the overlay images over the video images presented on the display device. In an example, when the distance to an object is determined, the overlay images are overlaid, in real-time, over the video presented by the camera. The objects in the images presented by the camera may be in the camera's range. In some examples, the objects within the images may be outside the camera's field of view or video boundaries. The overlay images may be 2D or three-dimensional (3D) rendered objects. Again, certain modifications of the overlay images may be presented to the user based on a change in distance of the object within the video presented by the camera. Some modifications of the overlay images may include changing the opacity of the overlay images, changing the color of the overlay images, changing the size of the overlay images, changing the positioning of the overlay images, changing the brightness of the overlay images, changing the perspective of the overlay images, and changing the inclination of the overlay images, among other types of modifications based on the distance of the object relative to the mobile device.

During operation of the mobile device, a user may use the FPV camera on the mobile device to navigate the mobile device within an environment where the mobile device includes such mobility devices. By way of example, where the mobile device is an RC device as described in and example presented in connection with FIG. 1, the user may actuate a number of buttons on a remote-control device in order to cause wheels or tracks to convey the RC device (100) within an environment. As the user does so, the camera may present an FPV of the environment on a display device receiving the video feed from the camera. Again, the video presented by the display device may include overlay images presented by the video enhancement module the depict to a user objects within view that are to be avoided during conveyance of the RC device (100) through the environment.

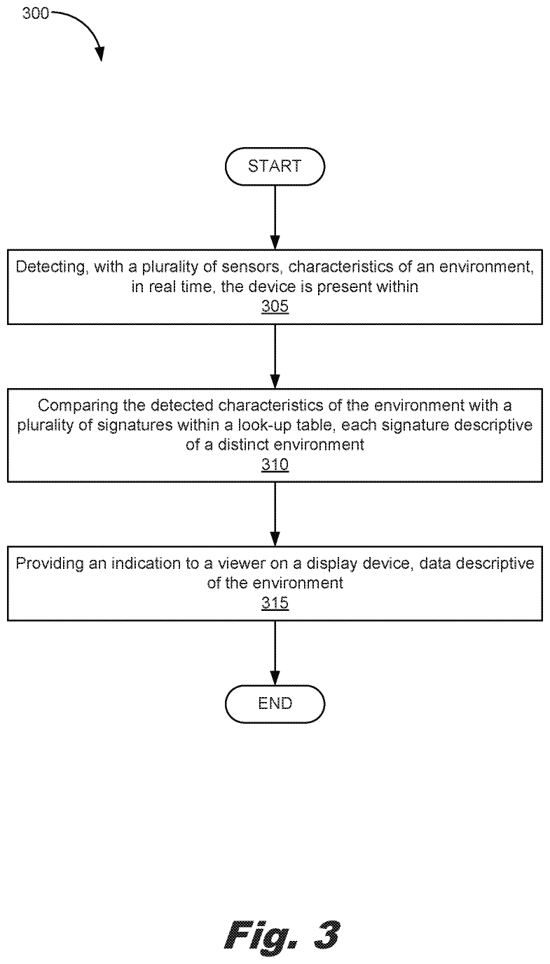

FIG. 3 is a flowchart showing a method (300) of determining a location of a remotely controlled device (FIG. 1, 100) according to an example of the principles described herein. The method (300) may begin with detecting (305), with a plurality of sensors, characteristics of an environment, in real time, the remotely controlled device is present within. As described herein, the sensors may include any sensor that may detect a characteristic of the environment. This data may be received by a processor of the mobile device (100) or other type of mobile device as described herein.

The method (300) may further include comparing (310) the detected characteristics of the environment with a plurality of signatures within a look-up table, each signature descriptive of a distinct environment. The signatures may have been developed using a signature module (115) prior to the detection (305) and stored in a data storage device associated with the mobile device (100) or mobile device described herein. The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage purposes. For example, in certain examples the processor may boot from Read Only Memory (ROM), maintain nonvolatile storage in the Hard Disk Drive (HDD) memory, and execute program code stored in Random Access Memory (RAM).

The data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device. The data storage device may store data such as executable program code that is executed by the processor (105) or other processing device. As will be discussed, the data storage device may specifically store computer code representing a number of applications that the processor executes to implement at least the functionality described herein.

The method (300) may also include providing (315) an indication to a viewer on a display device, data descriptive of the environment. In an example, a camera may provide to a user an actual view of the environment the mobile device is within. In this example, the data provided to the user may include both the images presented by the camera with overlay images indicating objects within the environment as described herein but also an indication of where the mobile device is located based, in part, on the physical layout of the objects in the environment. This may be done through the use of a rangefinder. In this example, the data from the rangefinder may be used to both present the overlay images over the images from the camera as well as detect the environment in which the mobile device is located by using the data to compare (310) to the signature.

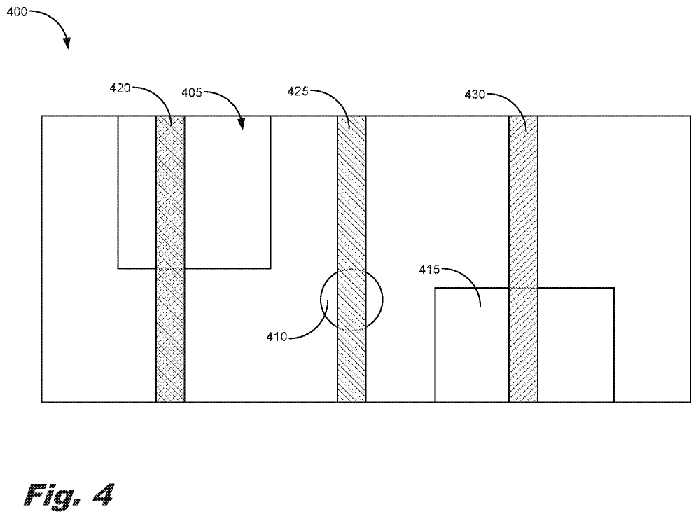

FIG. 4 is a view of a graphical user interface (GUI) (400) according to an example of the principles described herein. The GUI (400) may be any type of visual display a user of the mobile device may view image presented to a display device associated with the mobile device as described herein. In an example, the mobile device is an RC device that includes a camera to record the environment around the RC device. In this example, the video captured by the camera may be relayed, wirelessly, to the display device and presented on the GUI (400).

According to an example of the principles described herein, the mobile device may include a video enhancement module to present to the user a number of overlay images overlaying the video presented on the GUI (400). FIG. 4 shows three different overlay images (420, 425, 430) representing a distance, as detected by a rangefinder, of three different objects (405, 410, 415) respectively. Each of the objects (405, 410, 415) may be at different distances from the mobile device (or more exactly the rangefinder). In this example, a first object may be furthest away from the mobile device and a second object (410) may be at an intermediate distance to that of a third object (415) and the first object (405). According to this example, the three different overlay images (420, 425, 430) may represent such degrees of distance. A first overlay image (420) may include a fill, color, or transparency that indicates visually to a user that the first object (405) is at a furthest distance. Similarly, the second (425) and third overlay images (430) may represent to a user the intermediate and closest distances from the mobile device respectively. As can be seen, the fill is shown to be different in the second (425) and third overlay images (430) providing a differentiating characteristic to allow the user to discern the distance of the three different objects (405, 410, 415). Although a fill is shown as the distinguishing characteristics of the overlay images (420, 425, 430), the overlay images (420, 425, 430) may be differentiated using coloring, transparency, shape, and/or size of the overlay images (420, 425, 430).

The objects (405, 410, 415) shown in the GUI (400) of FIG. 4 may be a determined distance from the mobile device. The data describing these distances may be obtained using a rangefinder. This data may be used by the signature module (115) as described herein to determine the location of the RC device (100). Indeed, the distance data received from the rangefinder may be used to both create the signatures using the signature module (115) and compare the data to a signature using a comparison module (225) as described herein.

In an example and in order to achieve its desired functionality, the RC device or other mobile device (100) may include various hardware components. Among these hardware components may be a number of processors (105), a number of data storage devices, a number of peripheral device adapters, and a number of network adapters. These hardware components may be interconnected through the use of a number of busses and/or network connections. In one example, the processor (105), data storage device, peripheral device adapters, and a network adapter may be communicatively coupled via a bus.

The processor (105) may include the hardware architecture to retrieve executable code from the data storage device and execute the executable code. The executable code may, when executed by the processor (105), cause the processor (105) to implement at least the functionality of detecting, with a plurality of sensors, characteristics of an environment, in real time, the remotely controlled device is present within; comparing the detected characteristics of the environment with a plurality of signatures within a look-up table, each signature descriptive of a distinct environment; and providing an indication to a viewer on a display device, data descriptive of the environment, according to the methods of the present specification described herein. In the course of executing code, the processor (101) may receive input from and provide output to a number of the remaining hardware units.

The hardware adapters in the mobile device (100) enable the processor (105) to interface with various other hardware elements, external and internal to the mobile device (100). For example, the peripheral device adapters may provide an interface to input/output devices, such as, for example, the display device, a mouse, or a keyboard. The peripheral device adapters may also provide access to other external devices such as an external storage device, a number of network devices such as, for example, servers, switches, and routers, client devices, other types of computing devices, and combinations thereof.

The display device may be provided to allow a user of the or mobile device (100) to interact with and implement the functionalities described herein. The peripheral device adapters may also create an interface between the processor (105) and the display device, a printer, or other media output devices. The network adapter may provide an interface to other computing devices within, for example, a network, thereby enabling the transmission of data between the mobile device (100) and other devices located within the network such as the display device.

The number of modules (115, 215, 220, 225) used in the implementation of the mobile device (100) may include executable program code that may be executed separately by the processor (105). In this example, the various modules may be stored as separate computer program products. In another example, the various modules associated with the mobile device (100) may be combined within a number of computer program products; each computer program product comprising a number of the modules. In an example, the modules may be in the form of an application specific integrated circuit (ASIC) that, when accessed by the processor (105), implements the functionality described herein.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (105) of the mobile device (100) or mobile device or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A mobile device, comprising:
a processor to:
receive data from a sensor descriptive of an environment in which the mobile device is present;
with an environment signature module, create a signature of the environment defining the characteristics of the environment; and
present to a user, via a remote display device, a location identifier based on a comparison between the signature and the currently sensed characteristics of the environment and visual cues indicating objects proximate to the mobile device.

2. The mobile device of claim 1, wherein the sensor is a rangefinder that detects the distance from the remotely controlled device to objects in the environment.

3. The mobile device of claim 2, wherein, upon detection of objects in the environment, the processor, upon execution of a video enhancement module, causes a number of visual cues to be presented on the display device in real-time.

4. The mobile device of claim 3, wherein the visual cues are visually adjusted as the device moves within the environment.

5. The mobile device of claim 1, wherein the sensor is a microphone and wherein noise detected by the microphone is compared to noise characteristics defined by the signature.

6. The mobile device of claim 1, wherein the signature is associated with a tag describing the environment.

7. The mobile device of claim 1, wherein the sensor comprises:
a microphone;
a barometer;
a camera;
a thermometer;
an accelerometer;
a speedometer;
a wireless network antenna; or
combinations thereof.

8. The mobile device of claim 1, wherein the comparison between the signature and the currently sensed characteristics of the environment comprises adding a weight to a characteristic of the environment.

9. An environment signature module, comprising:
a plurality of sensors to detect characteristics of an environment a mobile device is physically present within;
a signature creation module to create and store a signature comprising data descriptive of characteristics of the environment based;
a tag creation module to receive input describing a tag to be associated with the signature; and
a comparison module to compare the signature to currently detected characteristics of an environment the mobile device is passing through.

10. The environment signature module of claim 9, comprising a weighting module to apply a weight to the detected characteristics of each of the plurality of sensors.

11. The environment signature module of claim 9, comprising a threshold module to apply a threshold to determine whether the signatures match the currently detected characteristics of the environment.

12. The environment signature module of claim 9, comprising a wireless network adapter to communicatively couple the environment signature module on the mobile device to a display device remote to the environment signature module on the mobile device and present the user with information regarding the tag associated with the signature and visual cues indicating objects proximate to the mobile device.

13. A method of determining a location of a device, comprising:
detecting, with a plurality of sensors, characteristics of an environment, in real time, the device is present within;
comparing the detected characteristics of the environment with a plurality of signatures within a look-up table, each signature descriptive of a distinct environment; and
providing an indication to a viewer on a display device, data descriptive of the environment.

14. The method of claim 13, wherein providing an indication to a viewer on a display device includes providing, via a camera on the device, video to the user and a visual cue overlaying the video indicative of the depth of any objects within the video.

15. The method of claim 13, wherein the plurality of sensors comprises:
a microphone;
a barometer;
a time and date reader;
a camera;
a fingerprint reader;
an iris reader;
a thermometer;
an accelerometer;
a speedometer;
a wireless network antenna; or
combinations thereof.
